(19) United States
(12) Patent Application Publication
(10) Pub. No.: US 2026/0284526 A1
(43) Pub. Date: Sep. 24, 2026

(54) GAME PROCESSING METHOD, NON-TRANSITORY COMPUTER-READABLE STORAGE MEDIUM HAVING GAME PROGRAM STORED THEREIN, AND GAME SYSTEM

(71) Applicant: NINTENDO CO., LTD., Kyoto-shi (JP)

(72) Inventor: Sho INABA, Kyoto-shi (JP)

(21) Appl. No.: 19/689,880

(22) Filed: May 27, 2026

Related U.S. Application Data
(63) Continuation of application No. PCT/JP2023/046176, filed on Dec. 22, 2023.

(51) Int. Cl. A63F 13/428; A63F 13/56; A63F 13/573; A63F 13/837; G06F 3/0346; G06F 3/0354

(52) U.S. Cl. CPC A63F 13/428; A63F 13/56; A63F 13/573; A63F 13/837; G06F 3/0346; G06F 3/03543

(57) ABSTRACT

A first control is executed based on data regarding movement of a mouse on a work surface, the data being based on output of a mouse sensor; a second control is executed based on data based on output of an inertial sensor configured to perform output corresponding to an attitude of the mouse, according to a degree of tilt of the mouse in a roll direction and/or a pitch direction; and a speed of a first object in a virtual space is decreased during execution of the second control.

### CROSS REFERENCE TO RELATED APPLICATION

This application is a continuation of International Application No. PCT/JP 2023/046176 filed on Dec. 22, 2023, the entire contents of which are incorporated herein by reference.

### FIELD

The present disclosure relates to information processing.

### BACKGROUND AND SUMMARY

Conventionally, a game that uses a mouse as an operation device is known.

In a game that uses a mouse as an operation device, there has been a demand for a novel game.

For example, the following configuration examples are provided.

One configuration example is directed to a computer-implemented method including: executing a first control, based on first data regarding movement of a mouse on a work surface, the first data being based on output of a first sensor configured to perform output corresponding to incident light through an opening provided in a bottom surface of the mouse; executing a second control, based on second data based on output of a second sensor configured to perform output corresponding to at least an attitude of the mouse, according to a degree of tilt of the mouse in a roll direction and/or a pitch direction; and executing a third control that decreases a speed of a first object in a virtual space during execution of the second control as compared to when the second control is not being executed.

According to the above configuration example, in a novel game in which a first control based on a movement operation on the mouse and a second control based on a tilting operation on the mouse are performed, a user can sufficiently concentrate on the tilting operation on the mouse.

In another configuration example, the computer-implemented method further includes: setting a parameter regarding movement of a second object in the virtual space, based on the first data and the second data; and causing a specified in-game effect to occur when the second object that has moved based on the set parameter is brought into a specified positional relationship with the first object.

According to the above configuration example, an advantageous in-game effect due to the second object being brought into the specified positional relationship with the first object becomes likely to occur, or a disadvantageous in-game effect becomes easy to avoid.

In another configuration example, the computer-implemented method further includes: setting a first parameter regarding the movement of the second object, based on the first data; setting a second parameter regarding the movement of the second object, based on the second data; and moving the second object, based on the first parameter and the second parameter.

According to the above configuration example, the second object can be moved according to the movement operation on the mouse and the tilting operation on the mouse.

In another configuration example, the first parameter is a parameter regarding a movement destination of the second object, and the second parameter is a parameter defining a trajectory for movement of the second object to the movement destination.

According to the above configuration example, it is possible to provide an operation for adjusting the movement destination of the second object based on the movement operation on the mouse and adjusting the trajectory of the second object based on the tilting operation on the mouse.

In another configuration example, the computer-implemented method further includes moving the second object, based on the first parameter and the second parameter if a specified operation is performed during the third control.

According to the above configuration example, it is easy to aim for the second object to be moved being brought into the specified positional relationship, or not being brought into it, with the first object whose speed has decreased.

In another configuration example, the computer-implemented method further includes terminating the third control if the specified operation is performed during the third control.

According to the above configuration example, since the decrease in the speed of the first object terminates, it is possible to prompt the user to, for example, terminate the tilting operation on the mouse and perform a movement operation on the mouse.

In another configuration example, the computer-implemented method further includes not executing the first control if the first data indicates that the mouse is moving on the work surface during the third control.

According to the above configuration example, it is possible to inhibit the first control from being unintentionally executed due to the first sensor reacting to a finger or the like during the tilting operation on the mouse.

In another configuration example, the computer-implemented method further includes terminating the third control and executing the first control if the first data indicates that the mouse is moving on the work surface during the third control.

According to the above configuration example, if the mouse is placed on a work surface having a different tilt and a movement operation on the mouse is performed, the third control can be terminated and the first control can be executed.

In another configuration example, the computer-implemented method further includes, after terminating the third control and executing the first control if the first data indicates that the mouse is moving on the work surface during the third control, executing the second control, based on the second data according to a degree of tilt from an attitude when the third control was terminated.

According to the above configuration example, even if the mouse is placed on a work surface having a different tilt and a movement operation on the mouse is performed, the second control can be appropriately executed thereafter.

In another configuration example, the computer-implemented method further includes: detecting that the mouse has been lifted from the work surface; and executing the third control, based on a result of the detecting.

According to the above configuration example, the user can, for example, calmly return the position of the mouse on the work surface.

According to an exemplary embodiment, it is possible to provide a game processing method, etc., that can realize a novel game in a game that uses a mouse as an operation device, for example.

Each configuration example described above may be read as a configuration example of one or more non-transitory computer-readable storage media or a game system.

### BRIEF DESCRIPTION OF THE DRAWINGS

FIG. 1 is a block diagram showing a non-limiting example of the internal configuration of a game apparatus 10;

FIG. 2 is a schematic diagram showing a non-limiting example of the appearance of a mouse;

FIG. 3 is a diagram illustrating an operation method for the mouse;

FIG. 4 is a diagram showing a non-limiting example of a game screen of a game;

FIG. 5 is a diagram illustrating an operation method for the game;

FIG. 6 is a diagram illustrating an operation method for the game;

FIG. 7 is a diagram illustrating an operation method for the game;

FIG. 8 is a diagram illustrating resetting of a reference attitude;

FIG. 9 is a diagram showing a non-limiting example of various data stored in a storage unit 12;

FIG. 10 is a non-limiting example of a flowchart of game processing; and

FIG. 11 is a non-limiting example of a flowchart of the game processing.

### DETAILED DESCRIPTION OF NON-LIMITING EXAMPLE EMBODIMENTS

Hereinafter, an exemplary embodiment will be described.

### Hardware Configuration of Information Processing Apparatus

An information processing apparatus (information processing system) for executing information processing according to the exemplary embodiment will be described. This information processing apparatus is a stationary or hand-held game apparatus, a personal computer, a tablet terminal, a smartphone, a wearable terminal, or the like, for example. The information processing apparatus according to the exemplary embodiment may be a server, or may be composed of a game apparatus or the like as described above, and a specified server. In the exemplary embodiment, a case where the information processing apparatus is a stationary game apparatus (which may be simply referred to as “game apparatus”) will be described as an example.

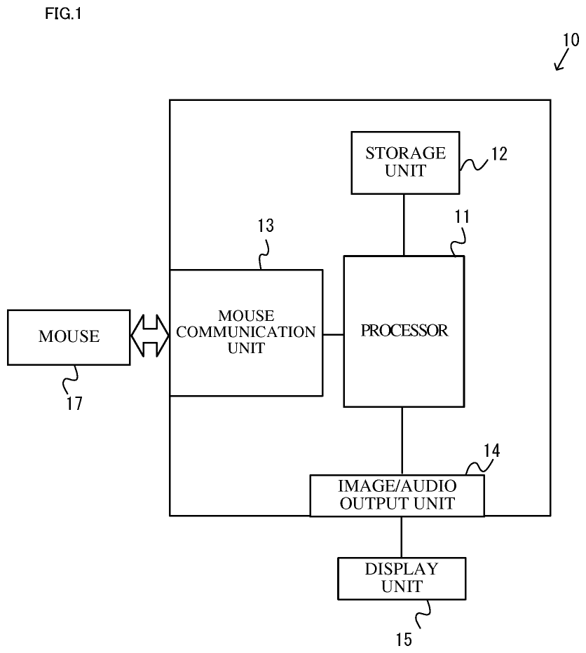

FIG. 1 is a block diagram showing an example of the internal configuration of a game apparatus (game system) 10 according to the exemplary embodiment. The game apparatus 10 includes a processor 11. The processor 11 is an information processing unit for executing various types of information processing to be executed in the game apparatus 10, and, for example, may be composed only of a CPU (Central Processing Unit), or may be composed of a SoC (System-on-a-chip) having a plurality of functions such as a CPU function and a GPU (Graphics Processing Unit) function. The processor 11 executes various types of information processing by executing an information processing program (for example, a game program) stored in a storage unit 12. The storage unit 12 may be an internal storage medium such as a flash memory or a DRAM (Dynamic Random Access Memory) or may be configured to utilize an external storage medium mounted to a slot that is not shown, or the like.

Also, the game apparatus 10 includes a mouse communication unit 13 for performing wired communication or wireless communication with a mouse 17.

Also, a display unit 15 (for example, a television or the like) is connected to the game apparatus 10 via an image-audio output unit 14. The processor 11 outputs images and audio generated (for example, by execution of the above-described information processing) to the display unit 15 capable of outputting audio, via the image-audio output unit 14.

Also, the game apparatus 10 includes a network communication unit (not shown) and can communicate with an external apparatus via a network. The network communication unit connects to a wireless LAN by a method compliant with, for example, Wi-Fi standards, and performs Internet communication, etc., with an external apparatus (another game apparatus 10). Also, the network communication unit can perform short-range wireless communication (for example, infrared communication) with another game apparatus 10.

The mouse 17 and the display unit 15 may be considered to be included in the game apparatus 10, or may be considered to not be included in the game apparatus 10.

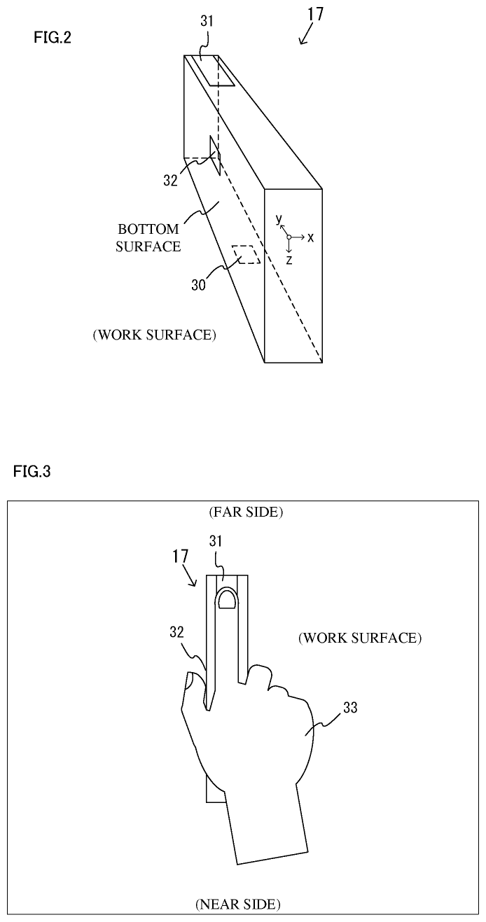

FIG. 2 is a schematic diagram showing an example of the appearance of the mouse 17. As shown in FIG. 2, the mouse 17 has a plate shape (a rectangular parallelepiped or a shape similar thereto in which the thickness in the x-axis direction is smaller than the thickness in the y-axis direction and the z-axis direction, and the thickness in the z-axis direction is smaller than the thickness in the y-axis direction) having the y-axis direction as a longitudinal direction.

The mouse 17 includes an inertial sensor. Specifically, the mouse 17 includes an acceleration sensor (not shown) and an angular velocity sensor (not shown). The acceleration sensor detects the magnitudes of accelerations along directions of specified three axes (x, y, and z axes in a mouse coordinate system shown in FIG. 2). Note that the acceleration sensor may be one that detects an acceleration along one axial direction or accelerations along two axial directions. Further, the angular velocity sensor detects angular velocities around specified three axes (x, y, and z axes shown in FIG. 2). Note that the angular velocity sensor may be one that detects an angular velocity around one axis or angular velocities around two axes. Then, detection results of the acceleration sensor and the angular velocity sensor are repeatedly transmitted to the mouse communication unit 13 at appropriate timings. Note that the mouse 17 may include only one of the acceleration sensor or the inertial sensor.

As shown in FIG. 2, the mouse 17 includes a sensor (which may be referred to as “mouse sensor”) 30 that detects operations such as a user sliding the mouse 17 on a work surface (a work surface with which a bottom surface shown in FIG. 2 is in contact), at the bottom surface. The mouse sensor 30 is, for example, a general mouse sensor (for example, an optical or laser type sensor), and is a sensor that outputs data (data corresponding to incident light through an opening provided in the bottom surface) for calculating movement (movement direction, movement distance, movement speed, etc.) on the work surface of the mouse 17 placed with the bottom surface facing the work surface. Also, as shown in FIG. 2, the mouse 17 includes a button 31 and a button 32. Data indicating operation states of the button 31 and the button 32 is repeatedly transmitted to the mouse communication unit 13 at appropriate timings. Also, the mouse 17 is provided with a vibration device (not shown) that vibrates the mouse 17.

FIG. 3 is a diagram illustrating an operation method for the mouse 17. The user holds the mouse 17 with a right hand 33 as shown in FIG. 3. Then, the user can perform an operation of moving the mouse 17 on the work surface as shown in FIG. 3, can press the button 31 with an index finger or a middle finger, and can press the button 32 with a thumb. Also, the user can perform an operation of tilting the mouse 17, an operation of lifting the mouse 17 from the work surface, etc.

The mouse 17 is a mouse for a right hand in which the button 32 is placed at a position where the button 32 is easily pressed with the thumb of the right hand. Hereinafter, a case where the user operates the mouse 17 with the right hand will be described. Note that in a case where the user operates with a left hand, a mouse for a left hand (not shown) may be used instead of the mouse 17 for a right hand. The mouse for a left hand differs from the mouse 17 for a right hand in that the button 32 is placed at a position where the button 32 is easily pressed with the thumb of the left hand (a position indicated by reference character 32 in a case where FIG. 3 is horizontally flipped).

### Game Assumed in Exemplary Embodiment

Next, an outline of game processing performed by the game apparatus 10 according to the exemplary embodiment will be described. A game assumed in the exemplary embodiment is, as an example, a game of throwing a disc and hitting a target. Specifically, the game is a game in which, in a virtual space, a player object (which may be referred to as “PO”) that makes actions according to a user operation throws a disc object (which may be simply referred to as “disc”) toward a target object (which may be simply referred to as “target”) that moves while being hidden by a moving obstacle object (which may be simply referred to as “obstacle”), and a score is given when the disc hits the target. Note that in another exemplary embodiment, the obstacle may be fixed to a ground without moving the obstacle. Also, this game is not limited thereto, and may be another type of games.

### Outline of Game Processing of Exemplary Embodiment

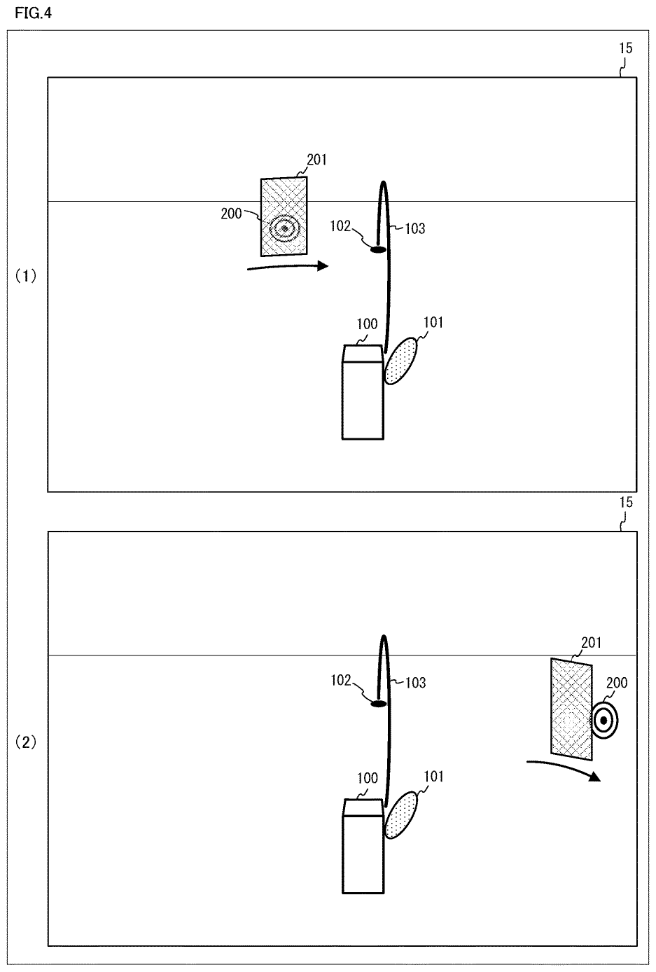

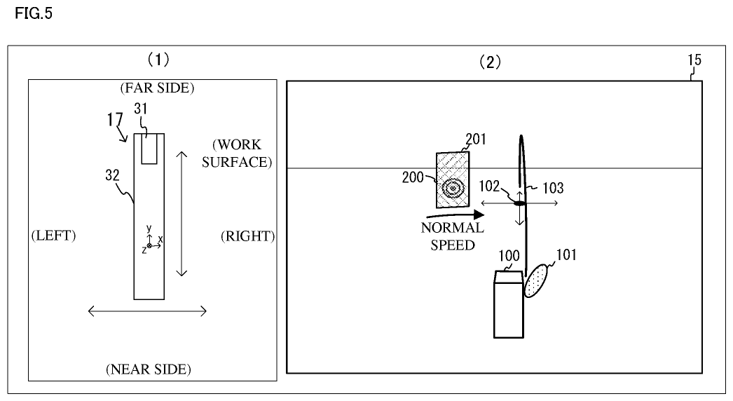

Next, an outline of operation of the game processing executed by the game apparatus 10 according to the exemplary embodiment will be described. FIG. 4 is an example of a game image in which a virtual space of this game is rendered. As shown in FIG. 4, a PO 100 holds a disc 101, and a target 200 is moving so as to be hidden by an obstacle 201. Also, as shown in FIG. 4, the target 200 and the obstacle 201 reciprocate with the same cycle on an arc having a center point (not shown) at a specified position in front of the PO 100, in a positional relationship where the center point, the obstacle 201, and the target 200 are located on a straight line. Also, the radius of the arc on which the obstacle 201 reciprocates is smaller than the radius of the arc on which the target 200 reciprocates. From this, near the ends of the arc (see FIG. 4(2)), the target 200 is exposed from the obstacle 201 as seen from the PO 100 compared to near the center of the arc (see FIG. 4(1)). Note that for example, the target 200 and the obstacle 201 may reciprocate with the same cycle on an arc having a center point at a specified position behind the PO 100 or an arc having a center point at the position of the PO 100, in a positional relationship where the center point, the obstacle 201, and the target 200 are located on a straight line.

Also, as shown in FIG. 4, a target position 102 where the thrown disc 101 reaches is displayed on a ground object (which may be simply referred to as “ground”), and a trajectory 103 until the disc 101 reaches the target position 102 is displayed. Note that the thrown disc 101 does not reach the target position 102 if the disc 101 hits the obstacle 201 or the target 200 on the way. Also, the target position 102 may not necessarily be displayed on the ground, and may be displayed on the obstacle 201 or the target 200. Also, the trajectory 103 does not have to be displayed so as to have the target position 102 as an end point, and may be displayed only up to its middle, or for example, if there is the obstacle 201 in the middle, the trajectory 103 may be displayed up to the obstacle 201. Note that one or both of the target position 102 and the trajectory 103 do not have to be displayed.

FIG. 5 is a diagram illustrating an operation for moving the target position 102. As shown in FIG. 5(1), when the mouse 17 is moved in a state where the bottom surface is in contact with the work surface, the mouse sensor 30 detects the movement. Then, the processor 11 determines that a “mouse movement operation” has been performed, based on the detected movement. As an example, the processor 11 determines that a mouse movement operation has been performed, when a movement amount detected by the mouse sensor 30 is equal to or greater than a specified amount. If it is determined that a mouse movement operation has been performed, the target position 102 moves on the ground according to the movement of the mouse 17 as shown in FIG. 5(2). Specifically, if it is determined that a mouse movement operation of moving the mouse 17 in the right, left, far-side, or near-side direction on the work surface has been performed, the target position 102 moves in the right, left, far-side, or near-side direction on the ground. Also, if it is determined that a mouse movement operation of moving the mouse 17 in a diagonal direction on the work surface has been performed, the target position 102 moves in a direction corresponding to the movement. The target position 102 moves by a movement amount corresponding to the movement amount by the mouse movement operation. Note that in FIG. 5 and subsequent figures, a hand of the user who operates the mouse 17 is not shown.

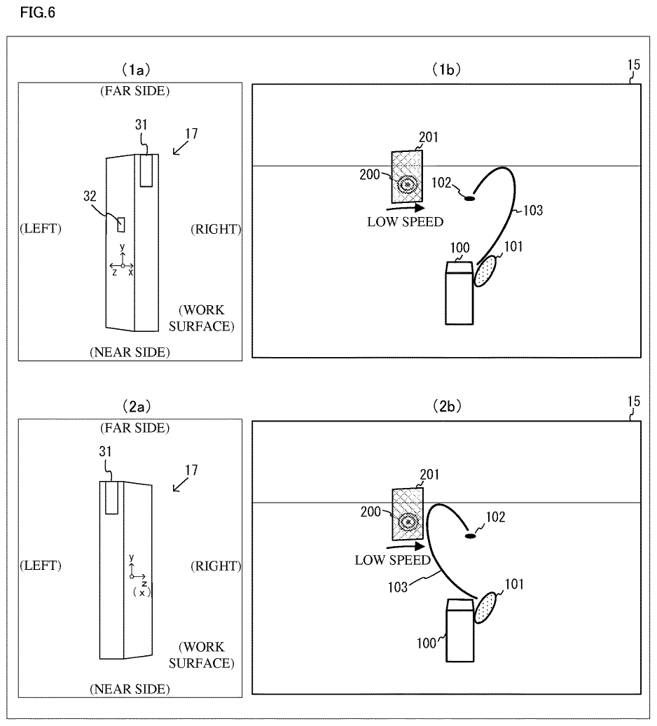

FIG. 6 is a diagram illustrating an operation for tilting the trajectory 103. When the attitude of the mouse 17 is tilted in the left-right direction, the inertial sensor detects the tilt. Then, the processor 11 determines that a “mouse tilting operation” has been performed, based on the detected tilt. The mouse tilting operation may be determined by using both the angular velocity sensor and the acceleration sensor among inertial sensors, or may be determined by using only one of these sensors. If it is determined that the mouse tilting operation has been performed, adjustment for tilting the trajectory 103 (which may be referred to as “trajectory tilt adjustment”) is performed according to a degree of tilt of the mouse 17 as shown in FIG. 6. Specifically, if it is determined that a mouse tilting operation of being tilted to the right side has been performed (see FIG. 6(1a)), the trajectory 103 tilts to the right side by an angle that the mouse 17 was tilted (see FIG. 6(1b)). Also, if it is determined that a mouse tilting operation of being tilted to the left side has been performed (see FIG. 6(2a)), the trajectory 103 tilts to the left side by an angle that the mouse 17 was tilted (see FIG. 6(2b)). Note that in an attitude where the mouse 17 is not tilted to the left or right and in a state where it is not determined that a mouse tilting operation has been performed, the trajectory 103 does not tilt and has a shape extending straight.

The mouse tilting operation may be determined by the mouse 17 tilting even slightly, or may be determined by the mouse 17 tilting to a certain degree or more. As an example, the mouse tilting operation may be determined by tilting at a tilt angle equal to or greater than an angle at which the mouse movement operation is no longer determined due to the mouse sensor 30 separating from the work surface (for example, 5 degrees for each of left and right), or may be determined by a tilt equal to or greater than a tilt less than that (for example, 2 degrees for each of left and right). Note that determination of a mouse tilting operation can be performed not only in a case where a part of the bottom surface of the mouse 17 is in contact with the work surface (see FIGS. 6(1a) and (2a)), but also in a case where the bottom surface of the mouse 17 is completely separated from the work surface.

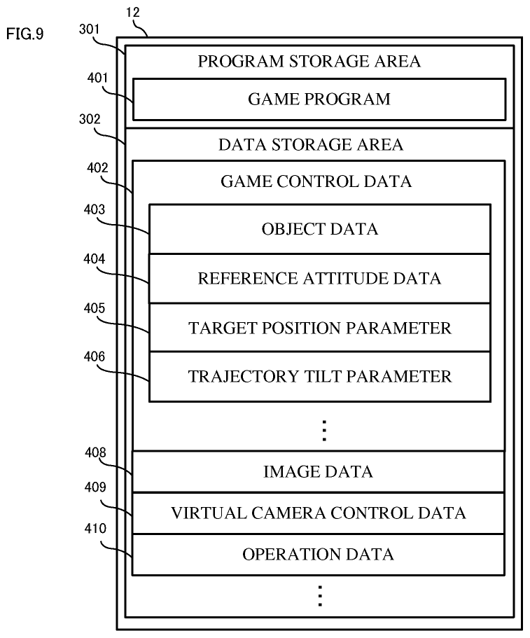

The trajectory 103 is a trajectory along which the thrown disc 101 moves while curving and rotating as shown in FIGS. 6(1b) and (2b). Also, since the mouse tilting operation is an operation determined by the mouse 17 being rotated and tilted in a roll rotation direction (rotation direction around the y-axis), it may be called an operation determined by being tilted in a “roll direction”. A tilt angle of the mouse 17 by determination of a mouse tilting operation is calculated based on a “reference attitude” for the mouse 17 described later using FIG. 8.

As shown in FIGS. 6(1a) and (2a), if the mouse 17 has been tilted and it is determined that a mouse tilting operation has been performed, the movement speeds of the target 200 and the obstacle 201 decrease (FIGS. 6(1b) and (2b)). This makes it easy for the user to aim for the target 200 by tilting the mouse 17 in order to hit the disc 101 on the target 200 by avoiding the obstacle 201 by the curved trajectory 103.

Note that in the exemplary embodiment, the movement speeds of the target 200 and the obstacle 201 decrease, but the present disclosure is not limited to this, and the speed of another object may decrease. For example, in a case where the target 200 attacks with a bullet, the speed of an action to attack (for example, at least one of an action to fire a bullet and an action of a bullet flying) may decrease. Also, for example, the speeds of action (including movement) of an object other than the target 200 and the obstacle 201 may be decreased. Also, for example, the speeds of actions of all (or some) objects other than the trajectory 103 whose trajectory tilt is adjusted by determination of a mouse tilting operation may be decreased. Also, a speed may be decreased to 0 (zero) gradually or instantaneously and to stop the object completely.

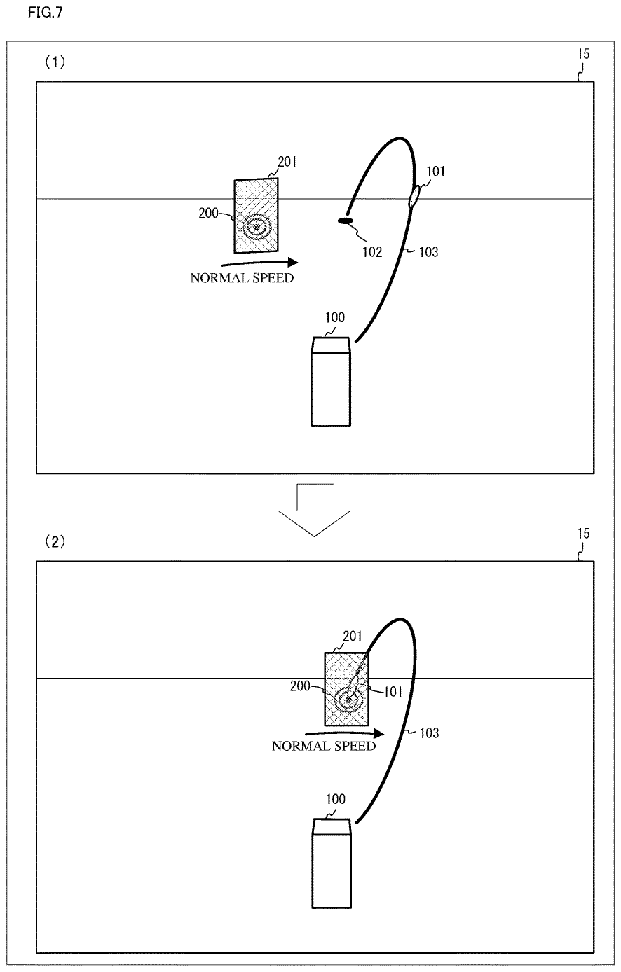

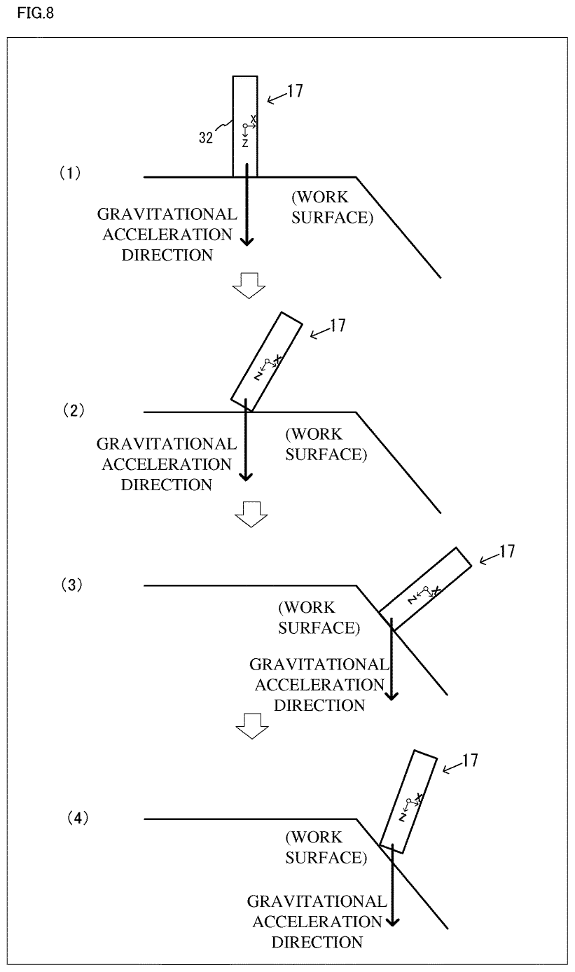

FIG. 7 is a diagram illustrating an operation for throwing the disc 101. If the button 31 of the mouse 17 is pressed when it is determined that a mouse tilting operation is being performed, movement of the disc 101 is started along the trajectory 103 at the time when the button 31 was pressed as shown in FIG. 7(1), and the movement speeds of the target 200 and the obstacle 201 return to a normal speed. When these movement speeds return to the normal speed, these movement speeds are maintained at the normal speed even if a mouse tilting operation is determined, until the mouse 17 returns to the original attitude (reference attitude) immediately before the mouse tilting operation was determined. Then, as shown in FIG. 7(2), if the disc 101 moving along the trajectory 103 hits the target 200 (without hitting the obstacle 201), a score is given. Note that after the mouse 17 returns to the original attitude, trajectory tilt adjustment and decrease in the movement speeds of the target 200 and the obstacle 201 are performed again according to determination of a mouse tilting operation. Note that the disc 101 does not have to move along the displayed trajectory 103. As an example, the disc 101 may move along a non-displayed trajectory that is deviated by a specified angle or a random angle from the displayed trajectory 103. Note that such a non-displayed trajectory is also adjusted according to a mouse tilting operation, similarly to the displayed trajectory 103.

If the disc 101 hits the obstacle 201 or the like in the middle of the trajectory 103, the disc 101 ends movement before reaching the target position 102. The disc 101 may remain by, for example, piercing an object (ground, target 200, obstacle 201, etc.) that the disc 101 hits. Also, during a period when the disc 101 is flying, it may be impossible to throw the next disc 101. Also, if the disc 101 cannot be launched since, for example, the PO 100 has taken damage or does not possess the disc 101, the movement speeds of the target 200 and the obstacle 201 may not necessarily be decreased even if a mouse tilting operation is determined.

Here, as described above, when it is determined that a mouse tilting operation is being performed, except for a case where the reference attitude described later using FIG. 8 is reset, it is difficult to adjust the target position 102 since the mouse sensor 30 is separated from the work surface. Therefore, the user might try to shorten a time for performing a mouse tilting operation as much as possible in order to shorten a period during which it is difficult to adjust the target position 102 and aim at the target 200. As a result, there is a risk that the user may no longer have sufficient margin for adjusting a degree of tilt of the trajectory 103 and the thrown disc 101 may hit the obstacle 201, thereby decreasing interest in aiming at the target 200 by adjusting the degree of tilt of the mouse 17. According to the exemplary embodiment, if a mouse tilting operation is determined and the trajectory 103 is tilted, the movement speeds of the target 200 and the obstacle 201 decrease. Therefore, necessity for the user to shorten the time for performing a mouse tilting operation becomes lower, and the user can concentrate on an operation for aiming at the target 200 by carefully adjusting the degree of tilt of the mouse 17. As a result of this, the user can concentrate on both a mouse movement operation and a mouse tilting operation.

Also, as described above, if the button 31 of the mouse 17 is pressed and the disc 101 is thrown when a mouse tilting operation is determined and the trajectory 103 is tilted, the decrease in the movement speeds of the target 200 and the obstacle 201 ends, and the target 200 and the obstacle 201 move at the normal speed until it is determined that the mouse 17 has returned to the original attitude. By this, it is possible to prompt the user to quickly return the mouse 17 to the original attitude and perform, for example, a mouse movement operation.

FIG. 8 is a diagram illustrating an attitude that becomes a reference for determining a tilt angle of the mouse 17 by a mouse tilting operation (which may be referred to as “reference attitude”) and setting of the reference attitude. As shown in FIG. 8, there is a possibility that a work surface to which the user returned the mouse 17 after tilting the mouse 17 is different from the original work surface and is tilted. Specifically, a case is considered in which, as shown in FIG. 8(1), an attitude in which the bottom surface of the mouse 17 is in contact with a work surface orthogonal to a gravitational acceleration direction (that is, an attitude of the mouse 17 in which the gravitational acceleration direction and the xy plane of the mouse coordinate system are orthogonal) is set as the reference attitude. Note that as an initial reference attitude at the start of the game, as an example, the attitude of the mouse 17 at a time point when it is determined that a mouse movement operation has been performed for the first time after the game was started is set.

In this case, if a mouse tilting operation in which the mouse 17 is tilted to the right direction as shown in FIG. 8(2) is determined, the trajectory 103 tilts in the right direction according to an angle tilted from the reference attitude, and the movement speeds of the target 200 and the obstacle 201 decrease (see FIGS. 6(1a) and (1b)). Thereafter, in a case where a mouse movement operation is determined while the bottom surface of the mouse 17 is in contact with on a work surface not orthogonal to the gravitational acceleration direction as shown in FIG. 8(3), the attitude of the mouse 17 at that time is reset as a new reference attitude. Also, simultaneously, the movement speeds of the target 200 and the obstacle 201 return to the normal speed. Thereafter, if a mouse tilting operation in which the mouse 17 is tilted to the left direction with respect to the reset reference attitude as shown in FIG. 8(4) is determined, the trajectory 103 tilts in the left direction according to an angle of the mouse 17 tilted from the reset work surface, and the movement speed of the target 200 decreases (see FIGS. 6(2a) and (2b)). By resetting the reference attitude for the mouse 17 as described above, it is possible to avoid a mouse tilting operation different from a user's intention being performed in a case where the tilt of the work surface has changed.

### Details of Information Processing of Exemplary Embodiment

Next, the information processing of the exemplary embodiment will be described in detail with reference to FIG. 9 to FIG. 11.

### Data to be Used

Various data to be used in the game processing will be described. FIG. 9 shows an example of data stored in the storage unit 12 of the game apparatus 10. As shown in FIG. 9, the storage unit 12 is provided with at least a program storage area 301 and a data storage area 302. In the program storage area 301, a game program 401 is stored. In the data storage area 302, game control data 402, image data 408, virtual camera control data 409, operation data 410, etc., are stored. The game control data 402 includes object data 403, reference attitude data 404, a target position parameter 405, and a trajectory tilt parameter 406.

The game program 401 is a game program for executing the game processing.

The object data 403 is data of objects to be placed in the virtual space, and is data of a player object, a target object, a disc object, a ground object, a trajectory object, a target position object, etc. Also, the object data 403 includes data of coordinates, orientations, postures, shapes, state, etc., of objects.

The reference attitude data 404 is data indicating a reference attitude that becomes a reference for determining a tilt angle of the mouse 17 by a mouse tilting operation.

The target position parameter 405 is a parameter that defines the position of the target position 102.

The trajectory tilt parameter 406 is a parameter that defines the tilt of the trajectory 103.

The image data 408 is image data of backgrounds, virtual effects, etc.

The virtual camera control data 409 is data for controlling the movement of a virtual camera to be placed in the virtual space.

The operation data 410 is data indicating contents of operations performed on the mouse 17. For example, the operation data 410 includes data indicating input states for actions (including a movement action on a work surface) and attitude change of the mouse 17, pressing states for various buttons, etc. The contents of the operation data are updated at a specified cycle based on a signal from the mouse 17.

In addition, various data to be used in the game processing and rendering processing are stored in the storage unit 12 as necessary.

### Details of Game Processing

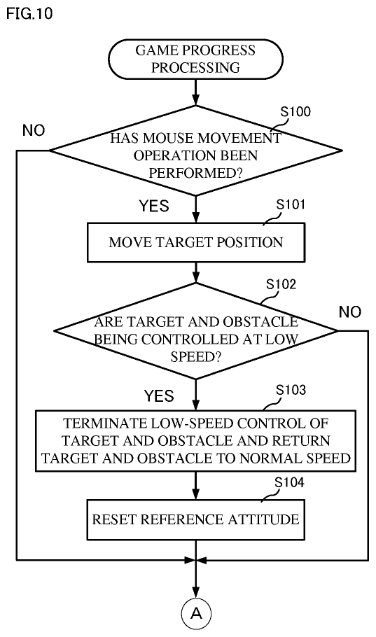

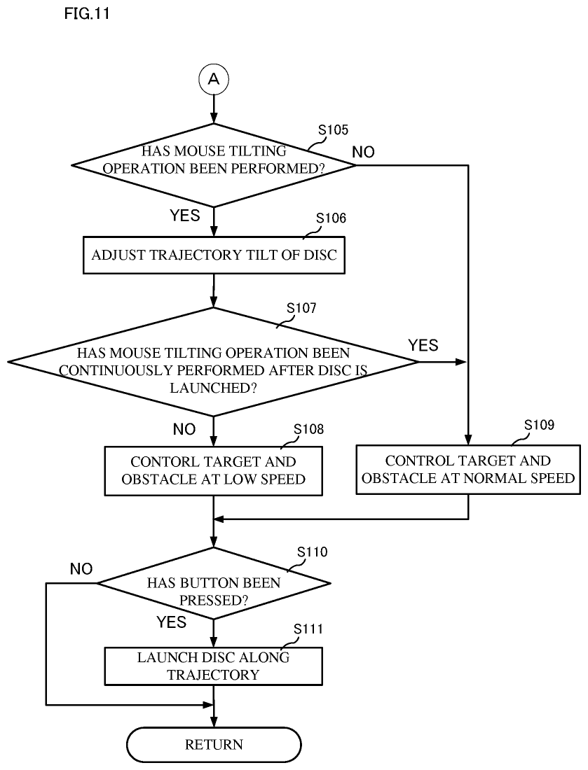

Next, the game processing according to the exemplary embodiment will be described with reference to flowcharts. FIG. 10 and FIG. 11 are an example of the flowcharts showing the game processing according to the exemplary embodiment. In the following, processing characteristic to the exemplary embodiment will be mainly described, and the description of other processing such as rendering processing is omitted.

When the game processing is started and the game is started, game progress processing in FIG. 10 and FIG. 11 is started. This processing is performed at predetermined intervals (for example, every rendering frame). When this game ends, the game processing ends.

First, in step S100 in FIG. 10, the processor 11 determines whether or not a mouse movement operation has been performed, based on the operation data 410 (data output from the mouse sensor 30). If this determination is YES, the processing moves to step S101, and in a case where this determination is NO, processing proceeds to step S105 in FIG. 11.

In step S101, the processor 11 sets the target position parameter 405 according to the mouse movement operation determined in step S100 (based on data output from the mouse sensor 30), and moves the target position 102 (see FIG. 5). The trajectory 103 may also be adjusted in accordance with the target position 102. Then, the processing proceeds to step S102.

In step S102, the processor 11 determines whether or not the target 200 and the obstacle 201 are being controlled at a low speed, based on the object data 403. If this determination is YES, the processing proceeds to step S103, and if this determination is NO, the processing proceeds to step S105 in FIG. 11.

In step S103, the processor 11 terminates the low-speed control of the target 200 and the obstacle 201 and returns the target 200 and the obstacle 201 to the normal speed (see description of FIG. 8(3)). Then, the processing proceeds to step S104.

In step S104, the processor 11 resets the reference attitude indicated by the reference attitude data 404 (see description of FIG. 8(3)). Then, the processing proceeds to step S105 in FIG. 11.

In step S105 in FIG. 11, the processor 11 determines whether or not a mouse tilting operation has been performed, based on the operation data 410 (data output from the inertial sensor of the mouse 17). If this determination is YES, the processing proceeds to step S106, and if this determination is NO, the processing proceeds to step S109.

In step S109, the processor 11 controls the target 200 and the obstacle 201 at the normal speed. Then, the processing proceeds to step S110.

In step S106, the processor 11 sets the trajectory tilt parameter 406 according to the mouse tilting operation determined in step S105 (based on data output from the inertial sensor of the mouse 17), and performs tilt adjustment of the trajectory 103 (see FIG. 6). Then, the processing proceeds to step S107.

In step S107, the processor 11 determines whether or not the tilting operation has been continuously performed on the mouse 17 after the disc 101 was thrown due to pressing of the button 31 being determined in the processing so far (see S110 and S111 described later). If this determination is YES, the processing proceeds to step S109, and if this determination is NO, the processing proceeds to step S108.

In step S108, the processor 11 controls the target 200 and the obstacle 201 at a low speed (see FIG. 6). Then, the processing proceeds to step S110.

In step S110, the processor 11 determines whether or not the button 31 of the mouse 17 has been pressed, based on the operation data 410. If this determination is YES, the processing proceeds to step S111, and if this determination is NO, the processing returns to step S100 in FIG. 10.

In step S111, the processor 11 causes the PO 100 to throw the disc 101 along the trajectory 103 formed based on the target position parameter 405 and the trajectory tilt parameter 406 (see FIG. 7). Then, the processing returns to step S100 in FIG. 10. If the thrown disc 101 moves along the trajectory 103 at the time of launching and hits the target 200, control for giving a score is performed.

According to the exemplary embodiment described above, the target position 102 to be reached by the disc 101 is moved by determination that a mouse movement operation has been performed (see FIG. 5), and the tilt of the trajectory 103 along which the disc 101 flies is changed by determination that a mouse tilting operation has been performed (see FIG. 6). By this, it is possible to provide a game of throwing the disc 101 (see FIG. 7) aiming at the target 200 moving while being hidden by the obstacle 201. Also, if the tilt of the trajectory 103 along which the disc 101 flies is changed by determination that a mouse tilting operation has been performed, the movement speeds of the target 200 and the obstacle 201 decrease. By this, the user can aim at the target 200 so as to avoid the obstacle 201 without rushing.

### Modifications

In the exemplary embodiment described above, an example in which the tilt of the trajectory 103 is changed according to determination that a mouse tilting operation of tilting the mouse 17 in the roll direction has been performed has been given (see FIG. 6). However, the trajectory 103 may be changed according to determination that a mouse tilting operation of tilting the mouse 17 in the roll direction and/or a pitch direction (rotation direction around the x-axis of the mouse coordinate system; see FIG. 2) has been performed. For example, the tilt of the trajectory 103 may be changed according to the tilt of the mouse 17 in the roll direction as described using FIG. 6, and a height of the trajectory 103 (curvature of a curve drawn by the trajectory 103; see FIG. 7, etc.) may be changed according to a degree of tilt of the mouse 17 in the pitch direction.

Also, in the exemplary embodiment described above, the game in which the PO 100 throws the disc 101 and hits the target 200 has been given as an example. However, the present disclosure is not limited to this. For example, there may be no PO 100 or obstacle 201, and the disc 101 or the target 200 may be other objects. Also, as another game example, the game may be a game in which a PO having a weapon swings down the weapon at an enemy or the like. In this case, for example, the position of the PO may be moved according to a mouse movement operation. Then, the weapon is swung up at an angle corresponding to a degree of tilt (swing-up angle) by a mouse tilting operation of tilting the mouse 17 in the pitch direction in which the button 31 faces the near side (setting the mouse 17 upright in the near-side direction in FIG. 3), and the weapon may be swung down according to a mouse tilting operation of returning the tilt of the mouse 17 (swinging down the mouse 17). Also, an enemy or the like may be damaged by the weapon being swung down with power corresponding to the above swing-up angle. Also, the enemy may take a defensive posture at an appropriate timing. Then, the motion speed of the enemy becomes slower during swinging up of the weapon, thereby making it easy for the user to aim at a timing when the defensive posture of the enemy was released and swing down the weapon. Also, for example, the tilt of a trajectory along which the weapon is swung down may be changed according to determination that a mouse tilting operation of tilting the mouse 17 in the roll direction (see FIG. 6) has been performed. Also, control performed corresponding to each of movement and tilting of a mouse is not limited. For example, various parameters such as speed may be set, or various items such as an action to be performed may be selected, according to each operation.

Also, if the tilt of the mouse 17 is detected when it is determined that a movement operation for the mouse 17 has been performed, the reference attitude may be reset while moving the target position 102 according to the mouse movement operation. For example, when the user operates the mouse 17 on a thigh, there is a high possibility that the attitude of the mouse 17 tilts during a mouse movement operation, since the top of the thigh is curved. At this time, for example, by a mouse tilting operation being determined to have been performed, there is a possibility that the trajectory 103 is tilted and the target 200, etc., are controlled at a low speed despite not being intended by the user. Therefore, during a period when it is determined that a mouse movement operation is being performed, by resetting the reference attitude according to the attitude of the mouse 17, it is possible to prevent low-speed control, etc., not intended by the user. Such resetting of the reference attitude may be performed when the detected tilt of the mouse 17 is tilted to a degree that a mouse tilting operation is determined, or may be performed even when a tilt of a smaller angle than that is detected. For example, the reference attitude may be constantly reset based on the tilt of the mouse 17 at that time. Also, a case where the work surface on which the mouse 17 is placed is tilted from the beginning is also conceivable, and the tilted attitude of the mouse 17 may be an initial setting of the reference attitude.

Also, on the other hand, the reference attitude does not have to be reset. For example, the reference attitude may be fixed to a attitude in which the gravitational acceleration direction is orthogonal to the xy plane of the mouse coordinate system. Then, if it is determined that a mouse movement operation has been performed when it is determined that a mouse tilting operation has been performed and the target 200, etc., are controlled at a low speed, control for not moving the target position 102 may be performed. By this, on a premise of performing a mouse movement operation on a work surface orthogonal to the gravitational acceleration direction, if the mouse 17 is placed on a work surface not orthogonal to the gravitational acceleration direction or if the user blocks the opening for the mouse sensor 30 with a finger or the like during a mouse tilting operation, the target position 102 can be prevented from moving according to a mouse movement operation against a user's intention.

Also, in the exemplary embodiment described above, low-speed control may be released based on establishment of a specified in-game condition such as a case where a specified time has elapsed from the start of the low-speed control or a case where the PO 100 is damaged during the low-speed control, when it is determined that a mouse tilting operation has been performed and the target 200, etc., are controlled at a low speed. At this time, the tilt of a trajectory based on the mouse tilting operation may also be released.

Also, in the exemplary embodiment described above, an example of changing the tilt of the trajectory 103 according to the tilt of the mouse 17 has been given (see description of FIG. 6). However, for example, after determining that the mouse 17 is in a state of being lifted from the work surface, the tilt of the trajectory 103 may be changed according to the tilt of the mouse 17 at that time. Whether or not the mouse 17 is in a state of being lifted from the work surface may be determined according to a situation of light detected by the mouse sensor 30, may be determined according to a distance from the work surface to a distance sensor provided at the bottom surface of the mouse 17, may be determined according to the magnitude of pressure by a pressure sensor provided at the bottom surface of the mouse 17, may be determined according to whether or not a button provided at the bottom surface of the mouse 17 is pressed, or may be determined using the inertial sensor. Also, whether the mouse 17 is in a state of being lifted from the work surface may be determined by the mouse 17 itself, or may be determined by the processor 11 based on data output from the mouse 17. Regardless of whether or not the mouse 17 is tilted, the target 200, etc., may be controlled at a low speed based on determining a state where the mouse 17 has been lifted from the work surface, or the target 200, etc., may be controlled at a low speed based on determining a state where the mouse 17 has been lifted from the work surface and the mouse 17 being tilted.

Also, in the exemplary embodiment described above, if it is determined that a mouse movement operation has been performed when it is determined that a mouse tilting operation has been performed and the target 200, etc., are controlled at a low speed, resetting of the reference attitude, etc., are performed. However, instead of determination that a mouse movement operation has been performed, control such as resetting of the reference attitude may be performed based on determining contact of the mouse 17 with a work surface. That is, determination of a mouse movement operation may be replaced with determination of contact of the mouse 17 with a work surface. For the determination of contact, the various sensors described above may be used.

Also, in the exemplary embodiment described above, an example in which the disc 101 flies along the trajectory 103 at a time point when the disc 101 was thrown has been given (see description of FIG. 7). However, for example, even during a period when the disc 101 is flying, a movement mode of the disc 101 may change according to a mouse movement operation and/or a mouse tilting operation. That is, it may be possible to operate the flying disc 101.

Also, the vibration device included in the mouse 17 may be vibrated according to the situation of a game to be executed or the state of the mouse 17. As an example, the vibration device may be vibrated when a mouse tilting operation is determined, or when a mouse tilting operation is determined and control based on determination of a mouse tilting operation such as low-speed control of the target 200, etc., is performed. Also, as an example, the vibration device may be vibrated based on determination of a mouse tilting operation being released, the mouse 17 returning to the reference attitude, or the reference attitude for the mouse 17 being reset. Also, as an example, the vibration device may be vibrated when a mouse movement operation is determined. Also, as an example, the vibration device may be vibrated according to the disc 101 hitting a target, or the target that was hit.

Also, in the embodiment described above, the target 200, etc., are controlled at a low speed when a mouse tilting operation is determined, but in another embodiment, the low-speed control may not necessarily be performed. Also in this case, for example, as in the exemplary embodiment, the trajectory 103 may be controlled based on the tilt of the mouse 17. Also in this case, if it is determined that a mouse movement operation has been performed during tilting of the mouse 17, control based on the mouse tilting operation such as returning the trajectory 103 to the original state may be released. Also, as an example, control of resetting of the reference attitude described above may be used in a game different from the game in the exemplary embodiment, or in processing other than the game.

In the exemplary embodiment described above (see FIG. 2), the mouse sensor 30 outputs data regarding reflected light from the work surface, and the game apparatus 10 (processor 11) calculates a movement direction, a movement amount, etc., based on the data. However, in another embodiment, the mouse 17 or the mouse sensor 30 may calculate and output the movement direction, the movement amount, etc. In the exemplary embodiment, whether or not the mouse has been moved on the work surface is determined, but the determination does not have to be made. Also, the game apparatus 10 or the mouse 17 or the mouse sensor 30 may calculate the current position of the mouse 17 in the mouse coordinate system, various kinds of processing may be performed based on this. For example, the mouse 17 may calculate the current position thereof in the mouse coordinate system and output this in addition to or instead of the movement direction and the movement amount. The same applies to the inertial sensor included in the mouse 17, and the game apparatus 10 or the mouse 17 may calculate an actual attitude, etc.

Also, the shape of the mouse 17 in the exemplary embodiment described above (see FIG. 2) is an example. For example, the mouse 17 may include a grip that is easy for the user to hold and lift. As an example, the mouse 17 may be able to be used like a general game controller. That is, a game controller having the mouse sensor 30 is included in a range of the mouse 17 in the present disclosure. Also, the mouse 17 may be attachable to and detachable from another apparatus. Also, in another embodiment, the mouse 17 may include, on its surface, a ball that can be rotationally operated. In this case, the mouse 17 may output substantially the same data as that when the mouse 17 is moved on the work surface, by rotating the ball as desired, instead of or in addition to a movement operation on the work surface. Then, game processing may be performed based on such data acquired from the mouse 17.

Also, in the embodiment described above, a case in which a series of processes regarding the game processing are executed in the single game apparatus 10 has been described. In another embodiment, the series of processes may be executed in an information processing system including a plurality of information processing apparatuses. For example, in an information processing system including a terminal-side apparatus and a server-side apparatus communicable with the terminal-side apparatus via a network, some of the series of processes above may be executed by the server-side apparatus. Further, in an information processing system including a terminal-side apparatus and a server-side apparatus communicable with the terminal-side apparatus via a network, major processes among the series of processes above may be executed by the server-side apparatus, and some of the processes may be executed in the terminal-side apparatus. Further, in the above information processing system, the system on the server side may be implemented by a plurality of information processing apparatuses, and processes that should be executed on the server side may be shared and executed by a plurality of information processing apparatuses. Further, a configuration of so-called cloud gaming may be adopted. For example, a configuration may be adopted in which: the game apparatus 10 sends operation data indicating operations performed by the user to a specified server; various kinds of game processing are executed in the server; and the execution results are streamed as moving images and audio to the game apparatus 10.

While the exemplary embodiment and the modifications have been described, the description thereof is in all aspects illustrative and not restrictive. In addition, it is to be understood that various improvements and changes can be made to the exemplary embodiment and modifications.

What is claimed is:

1. A computer-implemented method comprising:
executing a first control, based on first data regarding movement of a mouse on a work surface, the first data being based on output of a first sensor configured to perform output corresponding to incident light through an opening provided in a bottom surface of the mouse;
executing a second control, based on second data based on output of a second sensor configured to perform output corresponding to at least an attitude of the mouse, according to a degree of tilt of the mouse in a roll direction and/or a pitch direction; and
executing a third control that decreases a speed of a first object in a virtual space during execution of the second control as compared to when the second control is not being executed.

2. The computer-implemented method according to claim 1, further comprising:
setting a parameter regarding movement of a second object in the virtual space, based on the first data and the second data; and
causing a specified in-game effect to occur when the second object that has moved based on the set parameter is brought into a specified positional relationship with the first object.

3. The computer-implemented method according to claim 2, further comprising:
setting a first parameter regarding the movement of the second object, based on the first data;
setting a second parameter regarding the movement of the second object, based on the second data; and
moving the second object, based on the first parameter and the second parameter.

4. The computer-implemented method according to claim 3, wherein
the first parameter is a parameter regarding a movement destination of the second object, and
the second parameter is a parameter defining a trajectory for movement of the second object to the movement destination.

5. The computer-implemented method according to claim 3, further comprising moving the second object, based on the first parameter and the second parameter if a specified operation is performed during the third control.

6. The computer-implemented method according to claim 5, further comprising terminating the third control if the specified operation is performed during the third control.

7. The computer-implemented method according to claim 1, further comprising not executing the first control if the first data indicates that the mouse is moving on the work surface during the third control.

8. The computer-implemented method according to claim 1, further comprising terminating the third control and executing the first control if the first data indicates that the mouse is moving on the work surface during the third control.

9. The computer-implemented method according to claim 8, further comprising, executing the first control after terminating the third control if the first data indicates that the mouse is moving on the work surface during the third control, executing the second control, based on the second data according to a degree of tilt from an attitude when the third control was terminated.

10. The computer-implemented method according to claim 1, further comprising:
detecting that the mouse has been lifted from the work surface; and
executing the third control, based on a result of the detecting.

11. One or more non-transitory computer-readable storage media having stored therein instructions that, when executed, cause one or more processors to perform operations comprising:
executing a first control, based on first data regarding movement of a mouse on a work surface, the first data being based on output of a first sensor configured to perform output corresponding to incident light through an opening provided in a bottom surface of the mouse;
executing a second control, based on second data based on output of a second sensor configured to perform output corresponding to at least an attitude of the mouse, according to a degree of tilt of the mouse in a roll direction and/or a pitch direction; and
executing a third control that decreases a speed of a first object in a virtual space during execution of the second control as compared to when the second control is not being executed.

12. The one or more non-transitory computer-readable storage media according to claim 11, wherein the operations further comprise:
setting a parameter regarding movement of a second object in the virtual space, based on the first data and the second data; and
causing a specified in-game effect to occur when the second object that has moved based on the set parameter is brought into a specified positional relationship with the first object.

13. The one or more non-transitory computer-readable storage media according to claim 12, wherein the operations further comprise:
setting a first parameter regarding the movement of the second object, based on the first data;
setting a second parameter regarding the movement of the second object, based on the second data; and
moving the second object, based on the first parameter and the second parameter.

14. The one or more non-transitory computer-readable storage media according to claim 11, wherein the operations further comprise not executing the first control if the first data indicates that the mouse is moving on the work surface during the third control.

15. The one or more non-transitory computer-readable storage media according to claim 11, wherein the operations further comprise:
detecting that the mouse has been lifted from the work surface; and
executing the third control, based on a result of the detecting.

16. A game system comprising a mouse, one or more processors, and one or more non-transitory computer-readable storage media having stored therein instructions that, when executed, cause the one or more processors to perform operations, wherein
the mouse is configured to
transmit first data regarding movement of the mouse on a work surface, the first data being based on output of a first sensor configured to perform output corresponding to incident light through an opening provided in a bottom surface of the mouse, and
transmit second data based on output of a second sensor configured to perform output corresponding to at least an attitude of the mouse, and
the operations comprise:
receiving the first data, and executing a first control, based on the first data;
receiving the second data, and executing a second control, based on the second data according to a degree of tilt of the mouse in a roll direction and/or a pitch direction; and
executing a third control that decreases a speed of a first object in a virtual space during execution of the second control as compared to when the second control is not being executed.

17. The game system according to claim 16, wherein the operations further comprise:
setting a parameter regarding movement of a second object in the virtual space, based on the first data and the second data; and
causing a specified in-game effect to occur when the second object that has moved based on the set parameter is brought into a specified positional relationship with the first object.

18. The game system according to claim 17, wherein the operations further comprise:
setting a first parameter regarding the movement of the second object, based on the first data;
setting a second parameter regarding the movement of the second object, based on the second data; and
moving the second object, based on the first parameter and the second parameter.

19. The game system according to claim 16, wherein the operations further comprise not executing the first control if the first data indicates that the mouse is moving on the work surface during the third control.

20. The game system according to claim 16, wherein the operations further comprise:
detecting that the mouse has been lifted from the work surface; and
executing the third control, based on a result of the detecting.
